(19) United States
(12) Patent Application Publication
(10) Pub. No.: US 2020/0110797 A1
(43) Pub. Date: Apr. 9, 2020

(54) UNSUPERVISED TEXT STYLE TRANSFER SYSTEM FOR IMPROVED ONLINE SOCIAL MEDIA EXPERIENCE

(71) Applicant: International Business Machines Corporation, Armonk, NY (US)

(72) Inventors: Igor Melnyk, Yorktown Heights, NY (US); Cicero Nogueira Dos Santos, Yorktown Heights, NY (US); Inkit Padhi, Yorktown Heights, NY (US); Kahini Wadhawan, Yorktown Heights, NY (US); Abhishek Kumar, Yorktown Heights, NY (US)

(21) Appl. No.: 16/151,620

(22) Filed: Oct. 4, 2018

(51) Int. Cl. G06F 17/27; G06F 17/30

(52) U.S. Cl. CPC G06F 17/271; G06F 17/2785; G06F 17/2765; G06F 17/30707

(57) ABSTRACT

An unsupervised text style transfer method, system, and computer program product include classifying a style of an input message, translating the input message into a second style, re-writing the input message into a second message having the second style, and distributing the second message in the second style.

### BACKGROUND

The present invention relates generally to an unsupervised text style transfer method, and more particularly, but not by way of limitation, to a system, method, and computer program product to re-write social media posts into different styles based on an encoder-decoder framework.

Online social media has become an important way to communicate and exchange ideas. One way to improve user experience is to offer multiple ways to express the posts more easily and with less negative effects. The style used in a social media post can have an important impact on how the message is interpreted. For example, posts that contain a sad/negative tone are normally less pleasant than posts with regular/positive tone. On the other hand, the posts containing abusive/offensive language are entirely unacceptable.

Conventional techniques have a simple strategy of filtering out an entire offensive post. However, a user that is consuming some online content may not want an entirely filtered out message but instead have it in a style that is non-offensive and still be able to comprehend it in a polite tone. On the other hand, for those users who plan to post an offensive message, if one could not only alert that a content is offensive and will be blocked, but also offer a polite version of the message that can be posted, this could encourage many users to change their mind and avoid the profanity etc.

Other conventional techniques for automatic text generation are conditioned on stylistic attributes. However, these techniques require labeled data (e.g., parallel corpus) for training, limiting its applicability to the currently considered problem.

Thus, there is a need in the art for a text style transfer technique as a tool to improve user experience in online social media by offering an automatic system to detect and transform user's posts to predefined styles.

### SUMMARY

In an exemplary embodiment, the present invention provides a computer-implemented unsupervised text style transfer method, the method including classifying a style of an input message, translating the input message into a second style, re-writing the input message into a second message having the second style, and distributing the second message in the second style. One or more other exemplary embodiments include a computer program product and a system, based on the method described above.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for an unsupervised text style transfer method 100 according to an embodiment of the present invention;

FIG. 2 exemplarily depicts a system architecture 200 according to an embodiment of the present invention;

FIG. 3 exemplarily depicts an architecture 300 for a training phase of the encoder, decoder, and classifier,

FIG. 4 depicts a cloud-computing node 10 according to an embodiment of the present invention;

FIG. 5 depicts a cloud-computing environment 50 according to an embodiment of the present invention; and

FIG. 6 depicts abstraction model layers according to an embodiment of the present invention.

### DETAILED DESCRIPTION

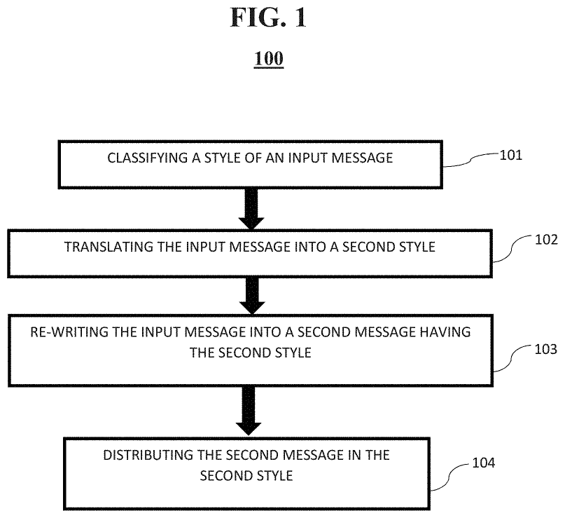

The invention will now be described with reference to FIGS. 1-6, in which like reference numerals refer to like parts throughout. It is emphasized that, according to common practice, the various features of the drawing are not necessarily to scale. On the contrary, the dimensions of the various features can be arbitrarily expanded or reduced for clarity.

By way of introduction of the example depicted in FIG. 1, an embodiment of an unsupervised text style transfer method 100 according to the present invention can include various steps for re-writing posts into different styles and is based on an encoder-decoder framework.

Thus, the invention can take as an input a message, feed it into an encoder and then decode it by transferring/rewriting it directly in a selected style, preserving the original content.

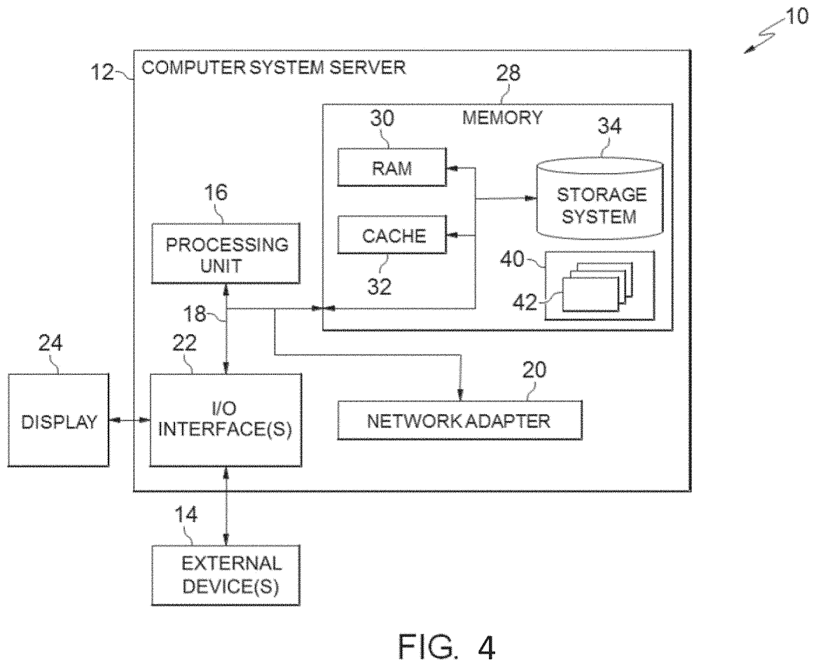

By way of introduction of the example depicted in FIG. 4, one or more computers of a computer system 12 according to an embodiment of the present invention can include a memory 28 having instructions stored in a storage system to perform the steps of FIG. 1.

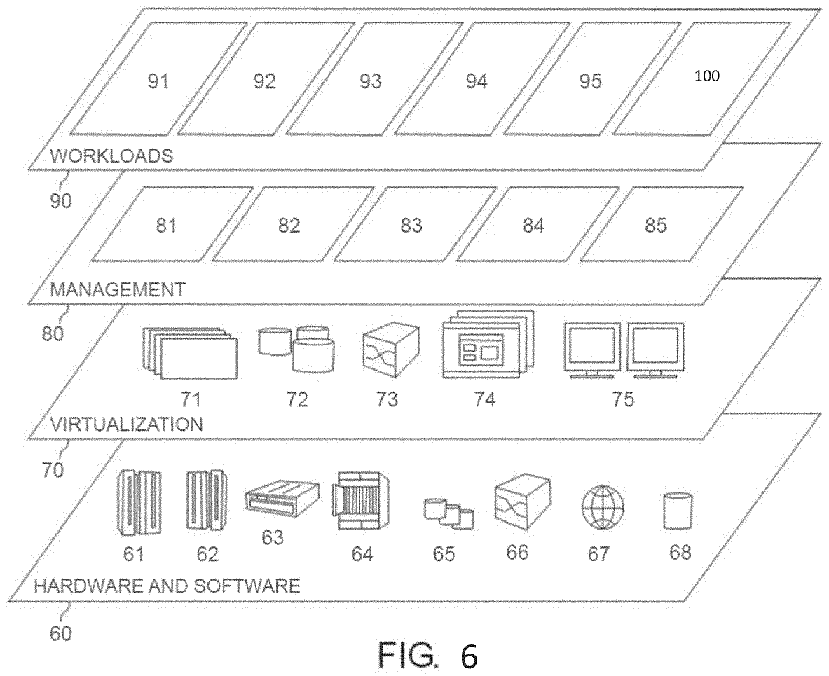

Although one or more embodiments may be implemented in a cloud environment 50 (e.g., FIG. 6), it is nonetheless understood that the present invention can be implemented outside of the cloud environment.

Referring generally to FIG. 1, a user on a social network (e.g., Twitter®, Reddit®, e-mail, text message, etc.) types an input message. The method 100 checks the message (e.g., using pre-trained classifiers) and determines its current style attributes such as sad/regular/funny, positive/neutral/negative, offensive/non-offensive etc. Next, the user is asked if they want the method to translate the text into a different style (e.g., from offensive to non-offensive, sad to happy, positive to negative, etc.). For instance, if the original text is sad and offensive, the method can suggest to rewrite it into a regular and non-offensive text, preserving the original content (e.g., merely re-phrasing message while still “meaning” the same thing). It is then up to the user whether to accept the suggestion or ignore it. Note that, in the case of offensive language, if the user ignores the alternative suggestion, it may now be up to the social network to determine whether to allow the original offensive message to be posted or filter it out.

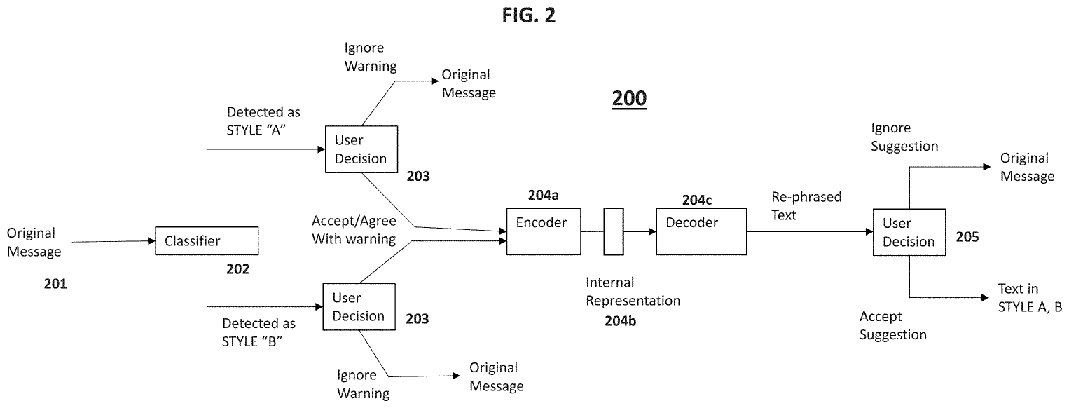

More specifically, with reference to FIGS. 1 and 2, in step 101, a style of the input message 201 is classified (e.g., by the classifier 202). The user can pre-empt the classification and deliver the input message “as is” (e.g., user decision 203).

In step 102, an encoder 204a translates the input message into a second style. The internal representation 204b includes the internal algorithm/variables of the encoding.

In step 103, the input message is re-written (e.g., re-phrased to maintain the original message but re-phrase the style) into a second message having a second style by a decoder 204c.

In step 104, the second message is distributed in the second style and the user can decide whether to accept the second message in a user decision module 205.

At a high level, the method 100 re-writes posts into different styles based on the encoder-decoder framework. However, it is assumed that there is no paired data (e.g., pairs of [sad, funny] sentences for instance) to train the encoder-decoder. Therefore, in order to train the encoder-decoder, two main challenges arise when dealing with non-parallel data: (a) there is no straightforward way to train the encoder-decoder because one cannot use maximum likelihood estimation on the transferred text due to the lack of ground truth; and (b) it is difficult to preserve content while transferring the input to a new style.

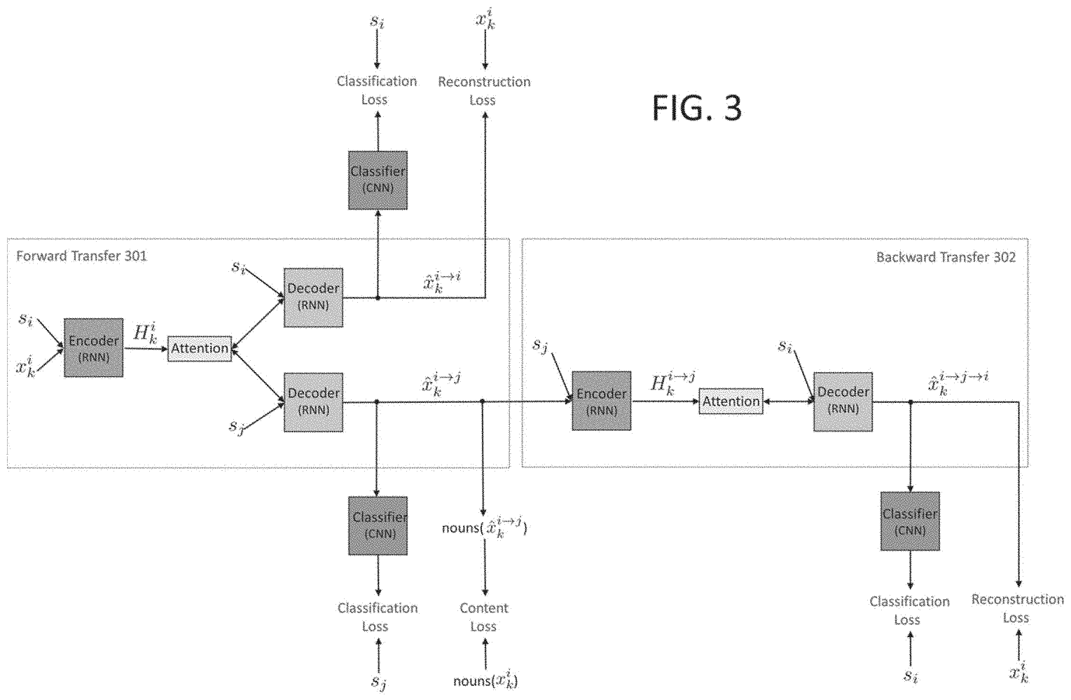

However, the invention addresses (a) by using a single collaborative classifier, as an alternative to commonly used adversarial discriminators. In addition, the invention addresses (b) by using the attention mechanism combined with a cycle consistency and noun preservation losses as seen in FIG. 3.

That is, as depicted in FIG. 2 and as trained in FIG. 3, the system is made up of three neural networks, each given a separate task during training. The encoder 204a parses the input sentence, and compresses the most relevant information—word meaning and syntax—into a real valued vector. This is read by a decoder 204c which produces a new generated sentence that is the translated version of the original one. That translated sentence is then evaluated by the third network (e.g., classifier 202) to identify whether the output has been correctly translated to the target style. Additionally, the nouns in the generated sentence are compared against the nouns in the original sentence—if the overlap is large, it means that the content is likely to be well preserved. For example, if the input message is talking about a feeling toward a restaurant, the output message should also include the noun “restaurant” to have the same “meaning” but phrased differently.

The generated sentence is also “back-translated” from the new style to the original one with the highest possible probability of closely matching the original sentence. If the results of any of the above evaluations contain errors during training, then the system is adjusted accordingly as depicted in FIG. 3.

It is noted that the invention uses a single classifier to do the same task. The main advantage of using a collaborative classifier is that in case when the text contains multiple attributes/styles and needs to be transferred to other multiple styles, the same classifier architecture can be used. Moreover, to explicitly preserve the content of the transferred sentence the method uses cycle consistency loss, the attention mechanism (e.g., as seen in FIG. 3), and the noun preservation loss.

With reference again to FIG. 2, the architecture of the system 200 includes two parts. An encoder neural network (in the form of a Recurrent Neural Network (RNN)) 204a, which encodes the input into a vector of numbers (e.g., vector representation), and the decoder neural network (in the form of RNN) 204c, which transforms the resulting vector representation of the input into the output. In-between the encoder 204a and decoder 204c there is also an attention mechanism (e.g., internal representation 204b) which gives the decoder additional power in creating output which might depend on any part of the input. The key assumption is that the vector representation encodes the relevant information that can be used by the decoder to produce the output.

Before the system 200 can be deployed as depicted in FIG. 2, it is trained as depicted in FIG. 3. For training the model, a large corpus of text for each style is used. FIG. 3 illustrates the training for the case of offensive/non-offensive style transfer, the training for the other styles is done in a similar way. The training begins with two sets of non-paired sentences: one set contains offensive sentences; the other set contains non-offensive sentences. First, the encoder-decoder is fed with an input message x (a message in the offensive style sᵢ) and an output sᵢ and sⱼ in two styles. sᵢ is in the same offensive style. This enables the comparison of sᵢ with the ground truth x using the reconstruction metric, which compares the x and sᵢ on the word level. The training also uses a classifier (e.g., in the form of Convolutional Neural Network (CNN)), which checks that sᵢ is indeed in the offensive style. The other output (sⱼ) is the transferred message in the non-offensive style. The training uses a classifier again to check that sⱼ now has a non-offensive style. Since there is no ground truth to check the quality of generated words in sⱼ, two mechanisms are utilized. One of the mechanisms is a noun-preservation loss, which compares the nouns in the original x and the transferred sⱼ messages. The idea is that to preserve content, both x and sⱼ sentences should have many similar nouns among them, and the noun-preservation loss specifically checks for this condition. The other mechanism is the so-called cycle consistency loss. For this, sⱼ is fed (e.g., a message in the non-offensive style) into an encoder and decoded back in the offensive style (sᵢ). Then, the training can utilize the reconstruction metric and compare the original message x in the offensive style with the “double-transferred” offensive message sᵢ on the word level. Finally, the training also uses the classifier again to check that sᵢ is indeed in the offensive style.

It is noted that the training checks word-by-word the translation to determine if the nouns align such that the sentence has the same semantic meaning but phrased differently. That is, the second message has the same topic as the first message except that the second message is phrased differently.

Once the training is done, the method 100 can take as an input a message, feed it into the encoder and then decode it by transferring/rewriting it directly in the selected style, preserving the original content.

### Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 4, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring now to FIG. 4, a computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further described below, memory 28 may include a computer program product storing one or program modules 42 comprising computer readable instructions configured to carry out one or more features of the present invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may be adapted for implementation in a networking environment. In some embodiments, program modules 42 are adapted to generally carry out one or more functions and/or methodologies of the present invention.

Computer system/server 12 may also communicate with one or more external devices 14 such as a keyboard, a pointing circuit, other peripherals, such as display 24, etc., and one or more components that facilitate interaction with computer system/server 12. Such communication can occur via Input/Output (I/O) interface 22, and/or any circuits (e.g., network card, modem, etc.) that enable computer system/server 12 to communicate with one or more other computing circuits. For example, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

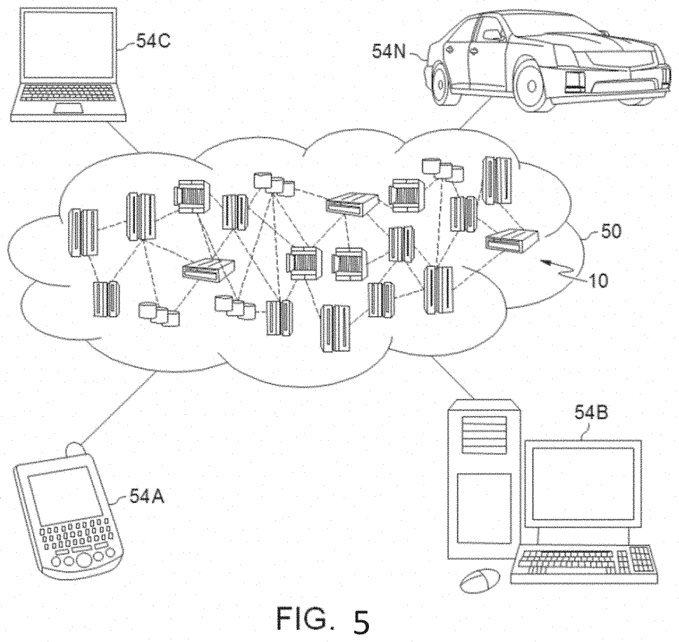

Referring now to FIG. 5, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 5 are intended to be illustrative only and that computing nodes 10 and cloud computing environment 50 can communicate with any type of computerized circuit over any type of network and/or network addressable connection (e.g., using a web browser).

Referring now to FIG. 6, an exemplary set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and unsupervised text style transfer method 100 in accordance with the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

1. A computer-implemented unsupervised text style transfer method, the method comprising:
classifying a style of an input message;
translating the input message into a second style;
re-writing the input message into a second message having the second style; and
distributing the second message in the second style,
wherein the re-writing authenticates the second message having the second style by comparing nouns of the re-written input message with nouns of the input message.

2. The computer-implemented method of claim 1, wherein the translating translates the message into the second style via an encoder that encodes the input message into a vector representation.

3. The computer-implemented method of claim 2, wherein the re-writing re-writes the input message into the second message via a decoder neural network that transforms the vector representation of the input message into the second message having the second style.

4. The computer-implemented method of claim 3, wherein an attention mechanism is placed between the encoder and the decoder to give the decoder additional power in creating the second message.

5. The computer-implemented method of claim 1, wherein the second message has a same content as the input message but is re-phrased to have the second style.

6. The computer-implemented method of claim 1, wherein the second style is conformed to the first style by comparing a noun presence for the first message with a noun presence for the second message.

7. The computer-implemented method of claim 1, wherein a single classification is performed.

8. The computer-implemented method of claim 1, wherein a user overrides the distributing of the second message such that the first message is distributed.

9. (canceled)

10. The computer-implemented method of claim 1, wherein, in a training phase, the re-writing re-writes the second message into a third message having an opposite style, and
wherein the third message is compared with the first message for a same style.

11. The computer-implemented method of claim 1, embodied in a cloud-computing environment.

12. A computer program product for unsupervised text style transfer, the computer program product comprising a computer-readable storage medium having program instructions embodied therewith, the program instructions executable by a computer to cause the computer to perform:
classifying a style of an input message;
translating the input message into a second style;
re-writing the input message into a second message having the second style; and
distributing the second message in the second style,
wherein the re-writing authenticates the second message having the second style by comparing nouns of the re-written input message with nouns of the input message.

13. The computer program product of claim 12, wherein the translating translates the message into the second style via an encoder that encodes the input message into a vector representation.

14. The computer program product of claim 13, wherein the re-writing re-writes the input message into the second message via a decoder that transforms the vector representation of the input message into the second message having the second style.

15. The computer program product of claim 14, wherein an attention mechanism is placed between the encoder and the decoder to give the decoder additional power in creating the second message.

16. The computer program product of claim 12, wherein the second message has a same content as the input message but is re-phrased to have the second style.

17. The computer program product of claim 12, wherein the second style is conformed to the first style by comparing a noun presence for the first message with a noun presence for the second message.

18. The computer program product of claim 12, wherein a single classification is performed.

19. An unsupervised text style transfer system, the system comprising:
a processor, and
a memory, the memory storing instructions to cause the processor to perform:
classifying a style of an input message;
translating the input message into a second style;
re-writing the input message into a second message having the second style; and
distributing the second message in the second style,
wherein the re-writing authenticates the second message having the second style by comparing nouns of the re-written input message with nouns of the input message.

20. The system of claim 19, embodied in a cloud-computing environment.
